(19) United States
(12) Patent Application Publication
(10) Pub. No.: US 2018/0137021 A1
(43) Pub. Date: May 17, 2018

(54) SYSTEM AND METHOD FOR VERIFYING GENERAL PURPOSE INPUT OUTPUT FUNCTIONS

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventor: CIA-YUN CHEN, New Taipei (TW)

(21) Appl. No.: 15/447,609

(22) Filed: Mar. 2, 2017

(30) Foreign Application Priority Data
Nov. 16, 2016 (CN) 201611009474.8

(51) Int. Cl. G06F 11/22; G06F 11/263

(52) U.S. Cl. CPC G06F 11/221; G06F 11/263; G06F 11/2221

(57) ABSTRACT

A system to verify the correct functioning of general purpose input output (GPIO) pins includes a main device and a processing chip. The main device stores a processing program, an executing program, and at least one predetermined value in relation to at least one GPIO parameter. The executing program is copied to a detection device and the processing program generates a mirror image document after compiling. The mirror image document is burned into the processing chip which is executed after the detection device is started. The executing program is executed as the processing chip is started. The executing program reads at least one actual GPIO value and verifies whether the at least one GPIO of the detection device is failed upon non-matching of the predetermined parametric value with the at least one GPIO actual value. A method to verify the correct functioning of the GPIO pins is also provided.

### FIELD

The subject matter herein generally relates to verifying systems.

### BACKGROUND

A motherboard defines a plurality of general purpose input output (GPIO) pins. A plurality of GPIO parameters is applied to each GPIO pin. Each GPIO parameter should be set and verified by a user.

### BRIEF DESCRIPTION OF THE DRAWINGS

Implementations of the present disclosure will now be described, by way of example only, with reference to the attached figures.

FIG. 1 is a block diagram of one exemplary embodiment of a system for verifying general purpose input output (GPIO) functions.

FIG. 2 is a diagram of a plurality of GPIO parameters of the system of FIG. 1.

FIG. 3 is a flowchart of one exemplary embodiment of a method for verifying GPIO functions.

FIG. 4 is a flowchart of one exemplary embodiment of a block 100 of the method of FIG. 3.

FIG. 5 is a flowchart of one exemplary embodiment of a block 300 of the method of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a general purpose input output verifying system and method to verify non-compliance with one GPIO parameter.

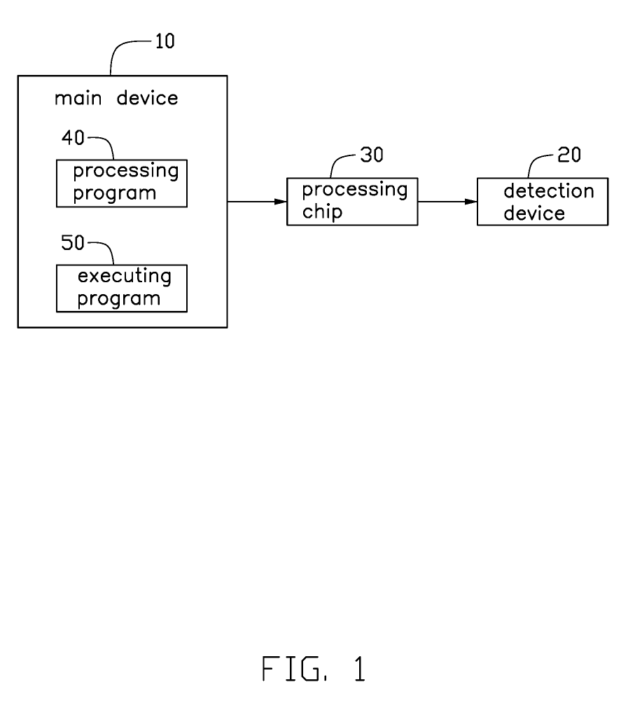

FIG. 1 illustrates an exemplary embodiment of a system for verifying general purpose input output (GPIO) functions. The system for verifying GPIO functions comprises a main device 10 and a processing chip 30 coupled to the main device 10. The processing chip 30 is defined on a detection device 20. The main device 10 stores a processing program 40 and an executing program 50. In at least one exemplary embodiment, the detection device 20 can be a personal computer or a server. The detection device 20 comprises a plurality of GPIO parameters.

In the exemplary embodiment, the main device 10 can be a computer.

The main device 10 defines a first storing directory and other second directories. The processing program 40 can be stored in the first storing directory or one of the other second storing directories. In the exemplary embodiment, the processing program 40 is stored in the first storing directory.

The processing program 40 comprises a source code of a basic input output system (BIOS) program.

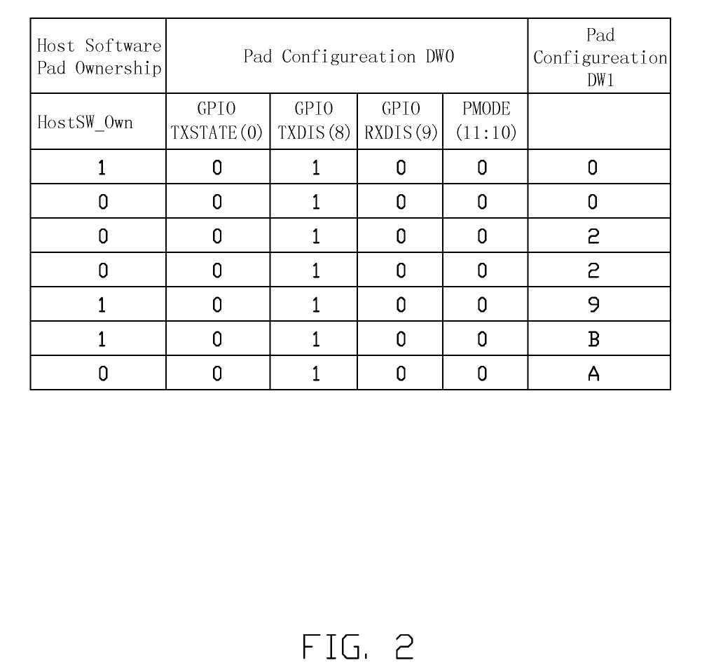

A user can set predetermined values. The predetermined values are stored in a predetermined file according to actual demands. Each predetermined value corresponds to one GPIO parameter. In the exemplary embodiment, the predetermined file is a spreadsheet file. The predetermined file further stores the plurality of GPIO parameters. FIG. 2 illustrates some of the plurality of the GPIO parameters of the predetermined file. In the predetermined file of FIG. 2, each row represents a plurality of GPIO parameters applicable to one GPIO, and each column represents one GPIO parameter which can apply to the plurality of GPIOs. For example, a column 1 and row 1 HostSW_Own as 1 can represent one GPIO parameter HostSW_Own of a first GPIO, and a column 1 and row 2 HostSW_Own as 0 can represent one GPIO parameter HostSW_Own of a second GPIO. A column 5 and row 1 PMODE as 0 represents one GPIO parameter PMODE of the first GPIO, and a column 5 and row 2 PMODE as 0 can represent one GPIO parameter PMODE of the second GPIO. In the exemplary embodiment, the predetermined file is stored in the first storing directory.

The source code of the BIOS program of the processing program 40 is compiled after the processing program 40 and predetermined file are stored together in the first storing directory. A mirror image document is generated after the source code of the BIOS program of the processing program 40 is compiled. The user can set the mirror image document to be generated in the first storing directory, or set the mirror image document to be generated in one of other second storing directories. In the exemplary embodiment, a filename extension of the mirror image document is “.h”.

The mirror image document is burned to the processing chip 30. The user can mount the processing chip 30 into a motherboard (not shown) of the detection device 20.

The executing program 50 is copied to the detection device 20. The user can copy the executing program 50 to an object file of the detection device 20 as required. In the exemplary embodiment, a filename extension of the executing program 50 is “.sh”.

The user can power on and boot up the detection device 20 when the processing chip 30 is mounted on the detection device 20 and the executing program 50 is copied to the detection device 20. The detection device 20 is configured to execute the mirror image document of the processing chip 30 after booting up. When the detection device 20 enters into a normal operating system (for example, a Windows operating system or a Linux operating system), the user can access the object file to execute the executing program 50. The executing program 50 is configured to read each actual value of the GPIO of the detection device 20 after executing. The executing program 50 is also configured to generate a current file corresponding to the actual values of the GPIO parameters after reading each actual value of the GPIOs. In the exemplary embodiment, the current file is a spreadsheet file. The user can store the current file to a determined file.

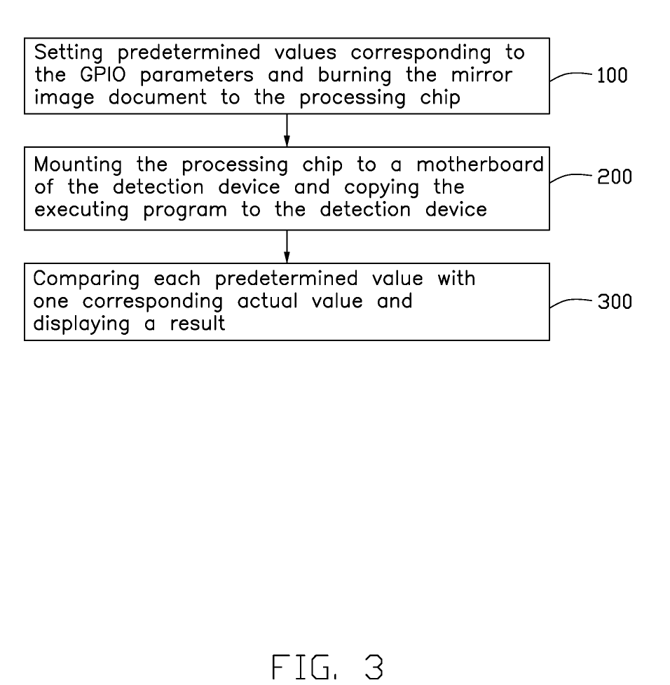

FIG. 3 illustrates a flowchart of a method in accordance with an example embodiment. A method for verifying general purpose input output (GPIO) functions is provided by way of example, as there are a variety of ways to carry out the method. The method described below can be carried out using the configurations illustrated in FIGS. 1-2, for example, and various elements of these figures are referenced in explaining the GPIO verifying method. The illustrated order of blocks is by example only and the order of the blocks can change. Additional blocks may be added or fewer blocks may be utilized without departing from this disclosure. The method for verifying general purpose input output (GPIO) functions can begin at block 100.

At block 100, set predetermined values as GPIO parameters and burn the mirror image document to the processing chip 30.

At block 200, mount the processing chip 30 to the motherboard of the detection device 20 and copy the executing program 50 to the detection device 20.

At block 300, compare each predetermined value with one corresponding actual value and display a result.

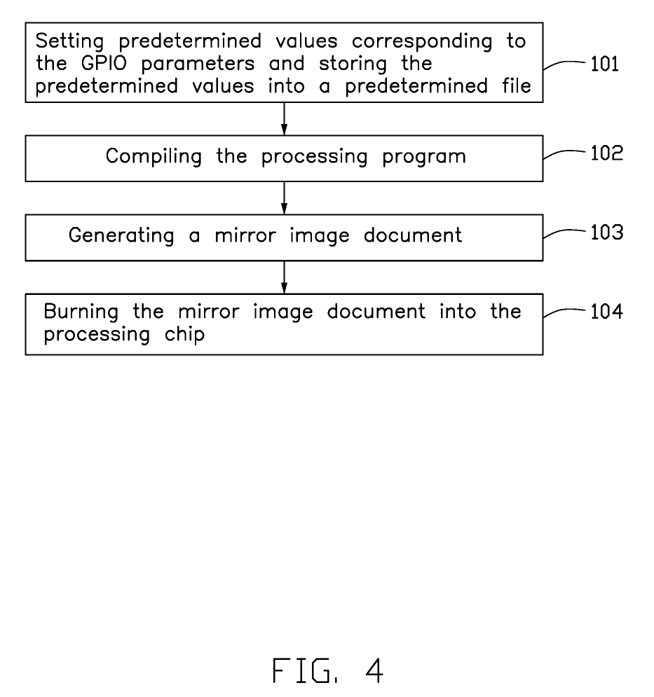

FIG. 4 illustrates a flowchart of the block 100 of the method in accordance with an example embodiment. The block 100 is provided by way of example, as there are a variety of ways to carry out the method. The block 100 described below can be carried out using the configurations illustrated in FIGS. 1-3, for example, and various elements of these figures are referenced in explaining the block 100. The illustrated order of blocks is by example only and the order of the blocks can change. Additional blocks may be added or fewer blocks may be utilized without departing from this disclosure. The block 100 can begin at block 101.

At block 101, set predetermined values as GPIO parameters and store the predetermined values into a predetermined file.

At block 102, compile the processing program 40. Specifically, when the processing program 40 and predetermined file are stored together in the first storing directory, the source code of the BIOS of the processing program 40 is compiled.

At block 103, a mirror image document is generated. Specifically, the user can set the mirror image document to be generated into the first storing directory or into the second storing directories.

At block 104, burn the mirror image document into the processing chip 30.

The processing chip 30 is mounted to the motherboard of the detection device 20 by the user and the executing program 50 is copied to the detection device 20 by the user according to actual demands. Specifically, the user copies the executing program 50 into an object file of the detection device 20.

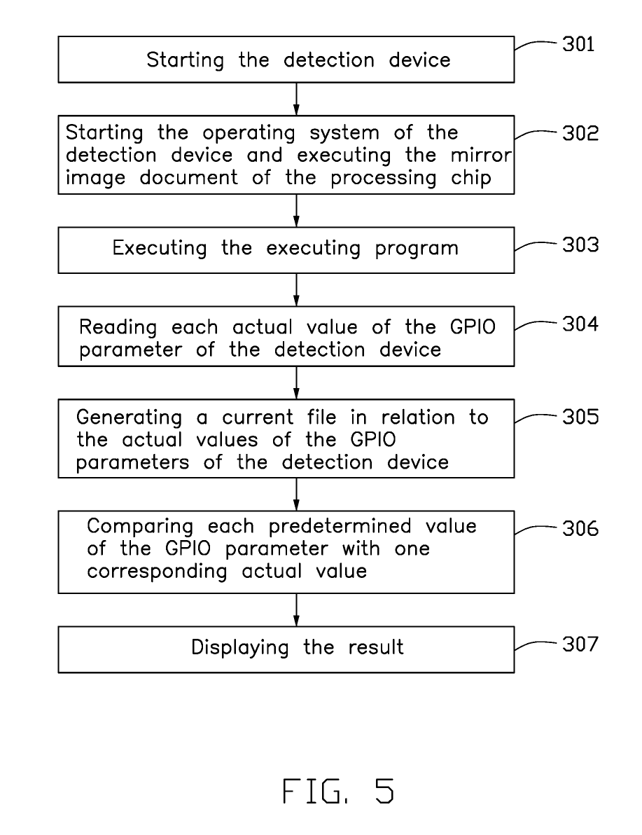

FIG. 5 illustrates a flowchart of the block 300 of the method in accordance with an example embodiment. The block 300 is provided by way of example, as there are a variety of ways to carry out the method. The block 300 described below can be carried out using the configurations illustrated in FIGS. 1-3, for example, and various elements of these figures are referenced in explaining the block 300. The illustrated order of blocks is by example only and the order of the blocks can change. Additional blocks may be added or fewer blocks may be utilized without departing from this disclosure. The block 300 can begin at block 301.

At block 301, start the detection device 20. Specifically, the detection device 20 is powered on and boots up.

At block 302, start the operating system of the detection device 20 and executing the mirror image document of the processing chip. Specifically, the mirror image document is started by the processing chip 30 after the operating system of the detection device 20 is started.

At block 303, execute the executing program 50. Specifically, the detection device 20 enters into a normal operating system interface, then execute the executing program 50.

At block 304, the executing program 50 reads each actual value of the GPIO parameter of the detection device 20.

At block 305, the executing program 50 generates a current file in relation to the actual values of the GPIO parameters of the detection device 20. Specifically, the current file stores a plurality of actual values corresponding to the GPIO parameters of the detection device 20.

At block 306, compare each predetermined value of the GPIO parameter with one corresponding actual value. Specifically, copy the predetermined values and actual values of the GPIO parameters of the detection device 20 into a comparing file to compare. In the exemplary embodiment, the comparing file is a spreadsheet file, the comparing file comprises a string E2 of a column 5 and row 2 and a string J2 of a column 10 and row 2. For example, when the string E2 of the column 5 and row 2 of the comparing file is different from the J2 string of the column 10 and row 2 of the comparing file and if the user wants to set different table cells to be the color red and yellow text, the user can select a “style” menu of an excel document to select an option of “conditional format”, then the user can select a “new format rule” and select a “confirming the setting format table cell by using formula” in the “new format rule”, set a “setting format (O) for meeting the value of the formula” of the “editing rule explanation (E)” as:“=NOT (EXACT(E2, J2))”.

At block 307, displaying the result. In one exemplary embodiment, mark the column that the predetermined value is different from the actual value to be red in color and yellow text.

In one exemplary embodiment, the user can check the comparison to conveniently verify the GPIO of the detection device 20, and to determine the failed GPIO.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A system for verifying general purpose input output (GPIO) functions comprising:
a processing chip defined on a detection device; and
a main device storing:
a processing program to generate a mirror image document after compiling;
an executing program configured to be copied to the detection device; and
at least one predetermined value in relation to at least one GPIO parameter;
wherein the mirror image document is burned into the processing chip;
wherein the processing chip is started after the detection device is started;
wherein the executing program is executed after the processing chip is started;
wherein the executing program is configured to read at least one actual value corresponding to the at least one GPIO parameter of the detection device after being executed;
wherein the at least one predetermined value is compared with the at least one actual value to verify whether the at least one GPIO parameter of the detection device is failed.

2. The system of claim 1, wherein at least one predetermined value in relation to at least one GPIO parameter is stored in a predetermined file, the processing program is compiled after the predetermined file and processing program are stored in a storing directory of the main device.

3. The system of claim 1, wherein at least one predetermined value in relation to at least one GPIO parameter is stored in a predetermined file.

4. The system of claim 3, wherein the predetermined file is a spreadsheet file.

5. The system of claim 1, wherein executing the executing program after the detection device is started to enter into a normal operating system.

6. The system of claim 1, wherein the executing program is configured to generate a current file corresponding to the at least one actual value file after executing.

7. The system of claim 6, wherein the current file is a spreadsheet file.

8. The system of claim 1, wherein the processing program comprises a source code of a basic input output system (BIOS) program.

9. The system of claim 1, wherein copy the at least one predetermined value and at least one actual value into a comparing file to compare the at least one predetermined value with the at least one actual value.

10. The system of claim 9, wherein the comparing file is a spreadsheet file.

11. A method for verifying general purpose input output (GPIO) functions comprising:
setting at least one predetermined value of at least one GPIO parameter;
generating a mirror image document;
burning the mirror image document into a processing chip;
starting the processing chip;
executing an executing program of the detection device;
reading at least one actual value of the at least one GPIO parameter of the detection device; and
comparing the at least one predetermined value with the at least one actual value.

12. The method of claim 11, further comprising a step of storing the at least one predetermined value of the at least one GPIO parameter into a predetermined file after the step of setting the at least one predetermined value of the at least one GPIO parameter.

13. The method of claim 11, further comprising a step of generating a current file in relation to the at least one actual value of the at least one GPIO parameter after the step of reading the at least one actual value of the at least one GPIO parameter of the detection device.

14. The method of claim 11, further comprising a step of displaying a result after the step of comparing the at least one predetermined value with the at least one actual value.

15. A method for verifying general purpose input output (GPIO) functions comprising:
setting at least one predetermined value of at least one GPIO parameter;
compiling a processing program;
generating a mirror image document;
burning the mirror image document into a processing chip;
starting the processing chip;
executing an executing program of the detection device;
reading at least one actual value of the at least one GPIO parameter of the detection device; and
comparing the at least one predetermined value with the at least one actual value.

16. The method of claim 15, further comprising a step of storing the at least one predetermined value of the at least one GPIO parameter into a predetermined file after the step of setting the at least one predetermined value of the at least one GPIO parameter.

17. The method of claim 15, further comprising a step of generating a current file in relation to the at least one actual value of the at least one GPIO parameter after the step of reading the at least one actual value of the at least one GPIO parameter of the detection device.

18. The method of claim 15, wherein the processing chip is mounted on a detection device.

19. The method of claim 15, wherein the step of comparing the at least one predetermined value with the at least one actual value comprises:
copying the at least one predetermined value and at least one actual value into a comparing file;
comparing the at least one predetermined value with the at least one actual value.

20. The method of claim 15, further comprising a step of displaying a result after the step of comparing the at least one predetermined value with the at least one actual value.
